(19) United States
(12) Patent Application Publication
(10) Pub. No.: US 2026/0062570 A1
(43) Pub. Date: Mar. 5, 2026

(54) INKJET INK AND IMAGE FORMING METHOD

(71) Applicant: Konica Minolta, Inc., Tokyo (JP)

(72) Inventors: Kenichiro HOSAKA, Tokyo (JP); Masashi IKEDA, Tokyo (JP); Yoshihito TAGUCHI, Kanagawa (JP); Shogo WATANABE, Tokyo (JP)

(21) Appl. No.: 19/256,388

(22) Filed: Jul. 1, 2025

(30) Foreign Application Priority Data
Sep. 4, 2024 (JP) 2024-152392

(51) Int. Cl. C09D 11/30; B41J 11/00; B41M 7/00; C09D 11/101; C09D 11/107

(52) U.S. Cl. CPC C09D 11/30; B41J 11/00214; B41M 7/0081; C09D 11/101; C09D 11/107

(57) ABSTRACT

An inkjet ink includes two or more types of waxes and a polymerizable compound and is curable by irradiation with an active ray. The sum of masses of the two or more types of waxes is 1.0% by mass to 10.0% by mass based on a total mass of the inkjet ink. Of a wax having a largest content by mass and a wax having a second largest content by mass among the two or more types of waxes, the melting point of a high-melting point wax is higher than the melting point of a low-melting point wax by 5° C. or more, and the content mass of the high-melting point wax is 1.0% by mass to 10.0% by mass with respect to the content mass of the low-melting point wax.

### CROSS REFERENCE TO RELATED APPLICATIONS

The entire disclosure of Japanese Patent Application No. 2024-152392 filed on Sep. 4, 2024, is incorporated herein by reference in its entirety.

### BACKGROUND

### Technological Field

The present invention relates to an inkjet ink and an image forming method.

### Description of Related Art

Inkjet recording methods are used in various printing fields because images can be formed easily and inexpensively. As an ink used in an inkjet recording method, an inkjet ink curable by active rays (hereinafter, referred to as inkjet ink) is known, which contains, as a liquid component, a polymerizable compound polymerizable by active rays (hereinafter, referred to as polymerizable compound). When the active ray-curable inkjet ink is irradiated with active rays, the active ray-curable inkjet ink is cured by polymerization of the active ray polymerizable compound, and the color material is firmly adhered to the base material. By forming the cured film, a desired image can be formed. As one type of inkjet ink, an inkjet ink containing a gelling agent (wax) is known (e.g., International Publication No. 2016/097180). In an inkjet ink containing a wax as a gelling agent, the wax is dissolved by heating the inkjet ink at the time of ejection, and then the wax is crystallized as the liquid temperature is lowered at the time the inkjet ink is deposited, thereby gelating the inkjet ink. By sufficiently increasing the gelling property of the inkjet ink, the inkjet ink is sufficiently thickened by cooling after landing on the base material, and the pinning property of the inkjet ink can be easily increased.

A varnish may be applied over the resulting image with an inkjet ink containing wax. In the image obtained by using such an inkjet, when the varnish is applied, the wettability of the varnish may be deteriorated, or the adhesiveness with the varnish layer may be deteriorated (the varnish suitability may be deteriorated).

According to the studies of the present inventors, the radiation-curable inkjet ink composition described in International Publication No. 2016/097180 has a problem that it is difficult to achieve both the pinning property of an inkjet ink and the varnish suitability of an image obtained from the inkjet ink.

### SUMMARY

The present invention has been made in consideration of the above-described circumstances, and an object of the present invention is to provide an inkjet ink curable by active rays and can achieve both pinning property of the inkjet ink and varnish suitability of an image to be formed. Another object of the present invention is to provide an image forming method using the inkjet ink.

To achieve at least one of the above-described objects, an inkjet ink reflecting one aspect of the present invention is an inkjet ink curable by irradiation with an active ray, the inkjet ink including two or more types of waxes and a polymerizable compound, in which a sum of masses of the two or more types of waxes is 1.0% by mass to 10.0% by mass based on a total mass of the inkjet ink, and when, of two types of waxes composed of a wax having a largest content by mass and a wax having a second largest content by mass among the two or more types of waxes, a wax whose melting point is higher is referred to as a high-melting point wax and a wax whose melting point is lower is referred to as a low-melting point wax, the melting point of the high-melting point wax is higher than the melting point of the low-melting point wax by 5° C. or more, and a content mass of the high-melting point wax is 1.0% by mass to 10.0% by mass with respect to a content mass of the low-melting point wax.

### BRIEF DESCRIPTION OF DRAWINGS

The advantageous and features provided by one or more embodiments of the invention will become more fully understood from the detailed description given hereinbelow and the appended drawings which are given by way of illustration only, and thus are not intended as a definition of the limits of the present invention:

FIG. 1 is a flowchart illustrating an image forming method according to the present embodiment; and

FIG. 2 is a schematic illustration of a configuration of an image forming apparatus capable of performing the image forming method according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Note that in the present specification, a numerical range indicated by using “to” means a range including numerical values described before and after “to” as a lower limit value and an upper limit value.

In addition, in the present specification. “(meth)acrylate” means any one or both of acrylate and methacrylate, and “(meth)acrylic” means any one or both of acrylic and methacrylic.

### 1. Inkjet Ink

An inkjet ink curable by active rays (hereinafter referred to as “inkjet ink”) in the present embodiment contains two or more types of waxes.

Hereinafter, the inkjet ink according to the present embodiment based on the above finding will be described in more detail.

### 1-1. Wax

The wax is a compound that dissolves in the polymerizable compound contained in the inkjet ink when the inkjet ink containing the wax is heated (for example, to 80° C.). Furthermore, the wax is a compound that crystallizes in the inkjet ink and causes the inkjet ink to gel due to a decrease in the liquid temperature (for example, 40° C.) when the inkjet ink is ejected from the inkjet head and deposited on the surface of the base material.

Of two types of waxes composed of a wax having the largest content by mass and the wax having the second largest content by mass among the two or more types of waxes, the wax whose melting point is higher is referred to as a high-melting point wax, and the wax whose melting point is lower is referred to as a low-melting point wax. In this case, those waxes satisfy the following three requirements.
(Requirement 1) The sum of the masses of the two or more types of waxes is from 1.0% by mass to 10.0% by mass based on the total mass of the inkjet ink.
(Requirement 2) The melting point of the high-melting point wax is higher than the melting point of the low-melting point wax by 5° C. or more.
(Requirement 3) The content mass of the high-melting point wax is 1.0% to 10.0% by mass with respect to the content mass of the low-melting point wax.

Both the pinning property of the inkjet ink and the varnish suitability of an image to be formed can be achieved by the two or more types of wax satisfying (Requirement 1) to (Requirement 3). The reason for this is not entirely clear, but is considered as follows.

In general, polymerizable compounds that impart active curability to inkjet ink include, for example, highly polar compounds such as acrylates and methacrylates. In addition, since it is necessary for the wax to be compatible with the polymerizable compound at the time of heating and to be crystallized at the time of cooling, for example, a functional group having low polarity such as a long-chain hydrocarbon group is introduced, and the compatibility with the polymerizable compound is adjusted to be low to some extent.

Among waxes, a high-melting point wax tends to crystallize even at a relatively high temperature in the inkjet ink and tends to cause the inkjet ink to gel, as compared to a low-melting point wax, and therefore tends to increase the pinning property of the inkjet ink. On the other hand, the high-melting point wax has a higher molecular weight than the low-melting point wax, for example, by increasing the number of hydrocarbon groups to be introduced, or has a lower polarity than the low-melting point wax by extending the chain length of the hydrocarbon group, and therefore tends to have poorer compatibility with the polymerizable compound than the low-melting point wax. Therefore, in the case where two or more types of waxes are used, when the addition ratio of the high-melting point wax is increased, the high-melting point wax is easily precipitated in the vicinity of the surface of the image at the time of image formation. When the varnish is applied to the obtained image, the varnish may contain, for example, a highly polar compound such as acrylate or methacrylate, similarly to the polymerizable compound. In this case, when the amount of the crystallized wax is large in the vicinity of the image surface, cissing tends to occur when varnish is applied (the varnish suitability tends to deteriorate).

Therefore, when the total amount of the waxes in the inkjet ink is adjusted so as not to be too large so as to satisfy (Requirement 1) and, among them, the addition ratio of the high-melting point wax having relatively low compatibility with the polymerizable compound to the low-melting point wax is decreased so as to satisfy (Requirement 3), the amount of the wax in the vicinity of the surface of the image during image formation tends to be decreased and the varnish suitability tends to be improved.

In addition, by adjusting the total amount of the wax in the inkjet ink so as not to be too small so as to satisfy (Requirement 1), it is possible to easily increase the gelling property of the inkjet ink. In addition, even when the addition ratio of the high-melting point wax is set to be low so as to satisfy (Requirement 2) and (Requirement 3), a small amount of the high-melting point wax having a structure different from that of the low-melting point wax prevents the low-melting point wax from being excessively densely aggregated when the low-melting point wax is crystallized in a plate shape, and thus voids (three dimensional spaces) can be easily generated. Thus, a structure in which the polymerizable compound is encapsulated (card house structure) is more likely to be formed, the inkjet ink is more likely to thicken, and the pinning property and the ejection property of the inkjet ink can be more likely to be enhanced.

Furthermore, even in a case where the addition ratio of the high-melting point wax is set to be low so as to satisfy (Requirement 2) and (Requirement 3), the high-melting point wax crystallizes first when the temperature of the inkjet ink decreases, becomes a seed crystal, and promotes the crystallization of the low-melting point wax. Therefore, even when the amount of the high-melting point wax added is relatively small, the gelation temperature of the inkjet ink can be sufficiently increased, and the gelling property of the inkjet ink can be easily increased.

From the foregoing, it is considered that when the two or more types of waxes satisfy (Requirement 1) to (Requirement 3), both the pinning property of the inkjet ink and the varnish suitability of the formed image are more likely to be achieved.

Examples of the wax include aliphatic ketones, aliphatic esters, glycerol-based compounds, pentaerythritol-based compounds, petroleum-based waxes, plant-based waxes, animal-based waxes, mineral-based waxes, hydrogenated castor oil, modified waxes, higher fatty acids, higher alcohols, hydroxystearic acid, fatty acid amides including N-substituted fatty acid amides and special fatty acid amides, higher amines, sucrose fatty acid esters, synthetic waxes, dibenzylidene sorbitol, dimer acids, and dimer diols. Among these, the wax is preferably an aliphatic ketone, an aliphatic ester, a higher fatty acid, or a higher alcohol, and more preferably an aliphatic ketone or an aliphatic ester from the viewpoint of increasing solubility in the polymerizable compound at a high temperature and easily increasing crystallinity in the polymerizable compound at a low temperature.

Examples of the aliphatic ketone include dibehenyl ketone, diheptadecyl ketone (stearone), distearyl ketone, dieicosyl ketone, dipalmityl ketone, dilauryl ketone, dimyristyl ketone, myristyl palmityl ketone, and palmityl stearyl ketone.

Examples of the aliphatic ester include the following:
fatty acid esters of monoalcohols such as behenyl behenate, icosyl icosanoate, stearyl stearate, palmityl stearate, behenyl stearate, myristyl myristate, cetyl myristate, oleyl palmitate and cetyl palmitate; and
fatty acid esters of poly hydric alcohols, such as glycerin fatty acid esters, sorbitan fatty acid esters, propylene glycol fatty acid esters, ethylene glycol fatty acid esters, polyoxyethylene fatty acid esters, and pentaerythritol fatty acid esters.

Examples of the pentaerythritol fatty acid esters include pentaerythritol tetrastearate, pentaerythritol distearate, pentaerythritol tetrapalmitate and the like.

Examples of the higher fatty acid include behenic acid, arachidic acid, stearic acid, palmitic acid, myristic acid, lauric acid, oleic acid, and erucic acid.

Examples of the higher alcohol include stearyl alcohol and behenyl alcohol.

Regarding the hydrocarbon chains in the aliphatic ketone and the aliphatic ester, from the viewpoint of more easily enhancing the gelling property, it is preferable that least one of the two carbon chains having a ketone group or an ester group therebetween has 12 to 22 carbon atoms, and it is more preferable that both of the two carbon chains have 12 to 22 carbon atoms. When the number of carbon atoms is 12 or more, the crystallinity of the wax is more likely to be enhanced, and a more sufficient space is more likely to be generated in the card house structure. Therefore, the polymerizable compound is more likely to be sufficiently included in the space, and the pinning property of the inkjet ink is more likely to be further enhanced. In addition, when both of the two carbon chains have 12 to 22 carbon atoms, the crystallinity is more likely to increase, and the pinning property is more likely to increase. In addition, when the number of carbon atoms is 22 or less, the solubility of the wax is more likely to increase, and the varnish suitability is easily improved.

Furthermore, the hydrocarbon chain in the aliphatic ketone and the aliphatic ester is preferably a linear hydrocarbon chain. When the hydrocarbon chain is linear, the polarity of the wax can be decreased, and thus the compatibility with the polymerizable compound tends to decrease and the crystallinity of the wax tends to increase.

Examples of the aliphatic ketone containing a hydrocarbon chain having 12 to 22 carbon atoms include dibehenyl ketone (carbon number: 21-22), diheptadecyl ketone (stearone) (carbon number: 17-17), distearyl ketone (carbon number: 17-18), dieicosyl ketone (carbon number: 19-20), dipalmityl ketone (carbon number: 15-16), dimyristyl ketone (carbon number: 13-14), dilauryl ketone (carbon number: 11-12), lauryl myristyl ketone (carbon number: 11-14), lauryl palmityl ketone (carbon number: 11-16), myristyl palmityl ketone (carbon number: 13-16), myristyl stearyl ketone (carbon number: 13-18), myristyl behenyl ketone (carbon number: 13-22), palmityl stearyl ketone (carbon number: 15-18), palmityl behenyl ketone (carbon number: 15-22), and stearyl behenyl ketone (carbon number: 17-22). The number of carbon atoms in the above parentheses represents the number of carbon atoms of each hydrocarbon chain bonded to the carbon atom of the carbonyl group.

Examples of the aliphatic ester containing a hydrocarbon chain having 12 to 22 carbon atoms include behenyl behenate (carbon number: 21-22), icosanoic acid icosyl (carbon number: 19-20), stearyl stearate (carbon number: 17-18), palmityl stearate (carbon number: 17-16), lauryl stearate (carbon number: 17-12), behenyl stearate (carbon number: 17-22), cetyl palmitate (carbon number: 15-16), stearyl palmitate (carbon number: 15-18), myristyl myristate (carbon number: 13-14), cetyl myristate (carbon number: 13-16), octyldodecyl myristate (carbon number: 13-20), stearyl oleate (carbon number: 17-18), stearyl erucate (carbon number: 21-18), stearyl linoleate (carbon number: 17-18), behenyl oleate (carbon number: 18-22), arachidyl linoleate (carbon number: 17-20), and pentaerythritol tetrastearate (carbon number: 17-17-17-17). The number of carbon atoms in the above parentheses represents the number of carbon atoms of each hydrocarbon chain bonded to the carbon atom or oxygen atom of the ester group.

Regarding (Requirement 1), it is preferable that the sum of the masses of the two or more types of waxes is 2.00% by mass to 8.00% by mass based on the total mass of the inkjet ink. The sum of the masses of the two or more types of waxes is more preferably 3.00% by mass to 6.00% by mass, and even more preferably 3.00% by mass to 4.00% by mass, based on the total mass of the inkjet ink. When the sum is 2.00% by mass or more, the gelling property of the inkjet ink becomes more likely to increase, and the pinning property of the ink becomes more likely to increase.

When the sum is 3.00% by mass or more, the pinning property of the ink is further easily enhanced. When the sum is 8.00% by mass or less, the amount of wax in the vicinity of the surface of an image during image formation is easily reduced, and the varnish suitability is more easily improved. When the sum is 6.00% by mass or less, the varnish suitability is more likely to be enhanced. In addition, when the sum is 4.00% by mass or less, the amount of the wax that is relatively less likely to be dissolved in the polymerizable compound to be added is reduced, and thus the wax is less likely to be precipitated in the vicinity of the nozzle at the time of ejection or before ejection, with the result that the ejection property is more likely to be enhanced.

Regarding (Requirement 2), examples of a method for obtaining a wax having a melting point higher by 5° C. or more includes the following: a method of increasing the number of hydroxy groups (the number of functional groups) in an alcohol used as a raw material of the aliphatic ester, a method of increasing the number of carbon atoms of hydrocarbon chains contained in the aliphatic ketone and the aliphatic ester, a method of reducing branched structures and using linear hydrocarbon chains, and a method of enhancing the symmetry of the molecular structure. Note that the melting point of each wax is a value obtained using a differential scanning calorimeter “Diamond DSC” (manufactured by PerkinElmer. Inc). The measurement of the melting point is performed under measurement conditions (temperature increase and cooling conditions) including a first temperature increase process of increasing the temperature from room temperature (25° C.) to 110° C. at a rate of 10° C./min and isothermally holding at 110° C. for 5 minutes, a cooling process of cooling from 110° C. to 0° C. at a cooling rate of 10° C./min and isothermally holding at 0° C. for 5 minutes, and a second temperature increase process of increasing the temperature from 0° C. to 110° C. at a rate of 10° C./min, in this order. The measurement is performed by sealing 3.0 mg of the sample in an aluminum pan and setting the pan in a sample holder of a differential scanning calorimeter “Diamond DSC”. An empty aluminum pan is used as a reference. In the above measurement, the endothermic curve obtained in the first temperature increase process was analyzed, and the top temperature of the endothermic peak (half-value width of 15° C. or less) derived from the crystalline polyester resin was referred to as the melting point (Tm) of the wax.

Regarding (Requirement 2), the melting point of the high-melting point wax is preferably higher than the melting point of the low-melting point wax by 10° C. or more, more preferably by 10° C. to 45° C. When the melting point difference is 10° C. or more, sufficient precipitation (seed crystals) of the high-melting point wax occurs at the time of the precipitation of the low-melting point wax, so that the gelling property tends to be enhanced. When the melting point difference is 45° C. or less, it is possible to prevent the seed crystals from becoming excessively large particles due to excessive crystallization of the high-melting point wax at the time when the low-melting point wax precipitates, and thus it is possible to easily increase the interaction with the low-melting point wax.

The melting points of the two or more types of waxes are all preferably 105° C. or less, more preferably 89° C. or less, and even more preferably 82° C. or less. When the melting point is 105° C. or lower, the wax is more likely to be dissolved in the polymerizable compound. In addition, when the melting point is 89° C. or lower, the rate of crystallization of the gelling agent becomes slower, a stronger card house structure is more likely to be formed, and the viscosity of the inkjet ink is more likely to increase. Furthermore, all of the melting points of the two or more types of the waxes are preferably 30° C. or higher, and more preferably 40° C. or higher. When the melting point is 30° C. or higher, the crystallinity of the wax can be further increased, and thus the gelling property can be more easily increased.

Regarding (Requirement 3), the content mass of the high-melting point wax is preferably from 2.0% by mass to 6.0% by mass, more preferably from 3.5% by mass to 5.5% by mass, with respect to the content mass of the low-melting point wax. When the content mass is 2.0% by mass or more, sufficient precipitation (seed crystals) of the high-melting point wax occurs, and therefore, the gelling property is more likely to increase and the pinning property is more likely to increase. When the content mass is 6.0% by mass or less, the addition ratio of the high-melting point wax which is relatively difficult to be dissolved in the polymerizable compound is decreased, the wax is less likely to be deposited on the surface of the image, and the varnish suitability is more likely to be enhanced. Furthermore, when the content mass is 6.0% by mass or less, the wax is less likely to precipitate in the vicinity of the nozzle during or before ejection, and thus the ejection property is more likely to increase.

The inkjet ink may contain two types of waxes, or three or more types of waxes, but from the viewpoint of making it easier to exhibit the effects of the present invention, the inkjet ink preferably contains two types of waxes. When the inkjet ink contains three or more types of waxes, the sum of the masses of two types of waxes composed of the wax having the highest content by mass and the wax having the second highest content by mass is preferably 85% by mass to 100% by mass, more preferably 90% by mass to 100% by mass, and still more preferably 95% by mass to 100% by mass, based on the total mass of the waxes contained in the inkjet ink.

The wax may or may not have a polymerizable group in the molecule. Specifically, the wax may or may not be polymerizable by active rays. When the wax has a polymerizable group, since a wax molecule is incorporated into a polymerized chain of the polymerizable compound, the wax is less likely to move, and thus it is possible to easily enhance the varnish suitability.

When the wax has a polymerizable group, it is preferable that the number of the polymerizable groups is from 1 to 3. From the viewpoint of facilitating linearization of the molecules of the wax and increasing the crystallinity of the wax, the number of the polymerizable groups is more preferably from 1 to 2.

Examples of the polymerizable group include a (meth)acryloyl group, a vinyl group, and an ethynyl group. Among these, a (meth)acryloyl group is preferable.

The weight average molecular weight of the gelling agent is preferably 150 to 1300, and more preferably 450 to 1000. The molecular weight can be measured using gel permeation chromatography.

### 1-2. Polymerizable Compound

The polymerizable compound is a compound which is polymerized and crosslinked by irradiation with active rays. The polymerizable compound is preferably a radically polymerizable compound.

In addition, the polymerizable compound is preferably a liquid at 30° C. from the viewpoint of adjusting the viscosity of the inkjet ink in the vicinity of room temperature and making it easy to improve the ejectability.

Examples of the active rays include electron beams, ultraviolet rays, α-rays, γ-rays, and X-rays. Among these, ultraviolet rays and electron beams are preferable, and ultraviolet rays are more preferable.

The radically polymerizable compound is a compound (a monomer, an oligomer, a polymer, or a mixture thereof) having a radically polymerizable ethylenically unsaturated bond. The radically polymerizable compounds may be used alone or in combination of two or more thereof.

Examples of the compound having a radically polymerizable ethylenically unsaturated bond include unsaturated carboxylic acids and salts thereof, unsaturated carboxylic acid ester compounds, unsaturated carboxylic acid urethane compounds, unsaturated carboxylic acid amide compounds, and anhydrides thereof. Other examples of the compound having a radically polymerizable ethylenically unsaturated bond include acrylonitrile, unsaturated polyester, unsaturated polyether, unsaturated polyamide, unsaturated urethane and the like. Examples of the unsaturated carboxylic acid include (meth)acrylic acid, itaconic acid, crotonic acid, isocrotonic acid, and maleic acid.

The radically polymerizable compound is preferably an unsaturated carboxylic acid ester compound, and more preferably a (meth)acrylate from the viewpoint of facilitating dissolution of the gelling agent in the ink.

Examples of the monofunctional (meth)acrylate include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethylhexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethylsuccinic acid, 2-(meth)acryloyloxyethylphthalic acid, 2-(meth)acryloyloxyethyl-2-hydroxyethyl-phthalic acid, and t-butylcyclohexyl (meth)acrylate.

Examples of the polyfunctional (meth)acrylate include bifunctional (meth)acrylates including triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, 1,10-decanediol di(meth)acrylate, neopentyl glycol di(meth)acrylate, tricyclodecanedimethanol di(meth)acrylate, hydroxypivalate neopentyl glycol di(meth)acrylate, polytetramethylene glycol di(meth)acrylate, polyethylene glycol diacrylate, and tripropylene glycol diacrylate; and trifunctional or higher functional (meth)acrylates including trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerolpropoxy tri(meth)acrylate, and pentaerythritol ethoxytetra(meth)acrylate.

Furthermore, the polymerizable compound preferably includes a (meth)acrylate having at least one (meth)acryloyl group, and preferably includes a polymerizable compound having two or more (meth)acryloyl groups. It is preferable that the polymerizable compound does not include a polymerizable compound having 10 or more (meth)acryloyl groups. When the number of (meth)acrylate groups is two or more, the polarity of the polymerizable compound is more likely to increase, the crystallinity of the wax is more likely to increase, and the pinning property of the inkjet ink is more likely to increase. When the polymerizable compound does not include a polymerizable compound having 10 or more (meth)acrylate groups, a crosslinked structure is appropriately formed. In such a case, the toughness of the image is enhanced, cohesive failure between the image and the varnish layer when the varnish is applied is easily suppressed, and the varnish adhesiveness is more likely to increase.

From the viewpoint of enhancing the compatibility with the wax and further enhancing the solubility of the wax, the radically polymerizable compound preferably contains a (meth)acrylate having an ethylene oxide (EO) group or a propylene oxide (PO) group. In general, a (meth)acrylate has an ester group and is more likely to have high polarity. On the other hand, an EO group or a PO group has a lower polarity than an ester group, and for example, the compatibility with a wax having a relatively low polarity such as a wax having a long-chain alkyl group is more likely to be enhanced.

The number of EO groups or PO groups contained in the (meth)acrylate having an EO group or a PO group is preferably 1 to 14, more preferably 2 to 12 or less.

Examples of the (meth)acrylate having an EO group or a PO group include polyethylene glycol diacrylate. EO-modified 1,6-hexanediol di(meth)acrylate. EO-modified nonylphenol (meth)acrylate. EO-modified cresole (meth)acrylate. EO-modified pentaerythritol tetraacrylate. EO-modified dipentaerythritol pentaacrylate. EO-modified dipentaerythritol hexaacrylate. EO-modified bisphenol-A diacrylate. EO-modified ditrimethylolpropane tetraacrylate. EO-modified trimethylolpropane tri(meth)acrylate. PO-modified nonylphenol (meth)acrylate. PO-modified neopentyl glycol diacrylate. PO-modified trimethylolpropane tri(meth)acrylate, and PO-modified bisphenol-A diacrylate.

The radically polymerizable compound may include a modified acrylate such as a urethane-modified acrylate, an epoxy-modified acrylate, or a polyester acrylate. Further, the radically polymerizable compound may contain an oligomer such as a polyester oligomer.

The polymerizable compound may include a cationically polymerizable compound. Examples of the cationically polymerizable compound include epoxy compounds, vinyl ether compounds, and oxetane compounds.

The HSP distance between the high-melting point wax and the polymerizable compound and the HSP distance between the low-melting point wax and the polymerizable compound are both preferably in the range of 2.5 to 6.5. Furthermore, both of the HSP distances are more preferably within a range of 3.0 to 6.5, and both of the HSP distances are further preferably 3.5 to 5.5. When both of the HSP distances are 2.5 or more, the compatibility between the wax and the polymerizable compound can be appropriately lowered, and thus the wax is easily crystallized at the time of cooling, and the pinning property can be easily enhanced. When both of the HSP distances are 3.5 or more, the compatibility with the polymerizable compound is moderately low, the wax is more likely to crystallize, and the wax mobility decreases, as a result of which the uneven distribution of the wax on the surface of an image is suppressed and therefore the varnish suitability is more likely to increase. When both of the HSP distances are 6.5 or less, the compatibility between each wax and the polymerizable compound is not excessively decreased, and the wax is less likely to be precipitated in the vicinity of the image surface, and therefore, the varnish suitability is more likely to increase. In addition, when the compatibility is appropriately increased, the viscosity is more likely to increase due to crystallization of the wax, and thus the ejection property and the pinning property are more likely to increase.

Note that the HSP distance between each wax and the polymerizable compound is calculated as follows.

First, the HSP value (Hansen Solubility Parameters: dispersion term (dD), polar term (dP), and hydrogen-bonding term (dH)) of each wax or each polymerizable compound is calculated using computer software. Hansen Solubility Parameters in Practice 5th Edition 5.0. 13 (HSPiP, manufactured by Tegara Corporation), by inputting the chemical structural formula into the software. The HSP value is based on the idea that “two substances having similar intermolecular interactions are more likely to dissolve in each other” (described in “Chemical Industry Press. Chemical Industry. March 2010 issue. Hiroshi Yamamoto. Steven Abbott, and Charles M. Hansen”). The HSP value is composed of the following three parameters, which can be regarded as coordinates in a three-dimensional space (also called “Hansen space”). The distance between the coordinates of two substances is referred to as the HSP distance, and it is considered that the closer the HSP distance is, the higher the affinity between the substances is and the easier the substances are to be dissolved.
δD: energy due to intermolecular dispersion force
δP: energy due to dipole interaction between molecules
δH: energy due to intermolecular hydrogen bonding

The HSP distance between the high-melting point wax or the low-melting point wax and the polymerizable compound (a mixture of polymerizable compounds when a plurality of types of polymerizable compounds are contained) is calculated by the following equation. Note that in the following equation, the dispersion term, the polar term, and the hydrogen bond term of one of the wax and the (mixture of the) polymerizable compound for which the HSP distance is calculated are denoted by dD, dP, and dH, respectively. In addition, the dispersion term, the polar term, and the hydrogen bond term of the other component are denoted by dD′, dP′ and dH′, respectively. In addition, in a case where a plurality of polymerizable compounds are included, a value obtained by adding values each obtained by multiplying the parameter (dD, dP, and dH) of each polymerizable compound by a molar ratio of the corresponding compound in the inkjet ink is set as the parameter (dD, dP, and dH) of the mixture of the polymerizable compounds.

$$HSP distance = {( 4 \times {( dD - {dD}^{′} )}^{2} + {( dP - {dP}^{′} )}^{2} + {( dH - {dH}^{′} )}^{2} )}^{1 / 2}$$

The content of the polymerizable compound is preferably 1% by mass or more and 97% by mass or less, more preferably 30% by mass or more and 95% by mass or less based on the total mass of the inkjet ink. In addition, the content of the polymerizable compound is more preferably from 50% by mass to 95% by mass, and most preferably from 70% by mass to 95% by mass based on the total mass of the inkjet ink.

### 1-3. Other Components

### 1-3-1. Coloring Agent

In the present embodiment, the inkjet ink may contain a coloring agent as necessary.

The coloring agent is a dye or a pigment, but a pigment is preferable because it has satisfactory dispersibility in the constituent components of the inkjet ink and excellent weather resistance. The pigment may be selected from, for example, yellow pigments, red or magenta pigments, blue or cyan pigments, black pigments, white pigments and the like, in accordance with a color or the like of an image to be formed.

Examples of the yellow pigments include C.I. Pigment Yellow (hereinafter, simply referred to as “PY”) 1, PY3, PY12, PY13, PY14, PY17, PY34, PY35, PY37, PY55, PY74, PY81, PY83, PY93, PY94, PY95, PY97, PY108, PY109, PY110, PY 137, PY138, PY139, PY153, PY 154, PY155, PY157, PY 166, PY 167, PY 168, PY 180, PY 185, and PY193.

Examples of the red or magenta pigment include C.I. Pigment Red (Hereinafter, also simply referred to as “PR”) 3, PR5, PR19, PR22, PR31, PR38, PR43, PR48:1, PR48:2, PR48:3, PR48:4, PR48:5, PR49:1, PR53:1, PR57:1. PR57:2, PR58:4, PR63:1, PR81, PR81:1, PR81:2, PR81:3, PR81:4, PR88, PR104, PR108, PR112, PR122, PR123. PR144, PR146, PR149, PR166, PR168, PR169, PR170, PR177, PR178, PR179, PR184, PR185, PR208, PR216. PR226, and PR257. C.I. Pigment Violet (hereinafter also simply referred to as “PV”) 3, PV19, PV23, PV29, PV30. PV37, PV50, and PV88, and C.I. Pigment Orange (hereinafter, also simply referred to as “PO”) 13. PO16. PO20, and PO36.

Examples of blue or cyan pigments include C.I. Pigment Blue (hereinafter also simply referred to as “PB”) 1, PB15, PB15:1, PB15:2, PB15:3, PB15:4, PB15:6, PB16, PB17-1, PB22, PB27, PB28, PB29, PB36, and PB60.

Examples of green pigments include C.I. Pigment Green (hereinafter also simply referred to as “PG”) 7, PG26, PG36, and PG50.

Examples of black pigments include C.I. Pigment Black (hereinafter also simply referred to as “PBk”) 7. PBk26, and PBk28.

The white pigment may be any pigment that imparts a white color to a cured film formed by curing the white ink. Examples of the white pigment include inorganic pigments such as titanium oxide, zinc oxide, calcium carbonate, barium sulfate, and aluminum hydroxide. Among these, titanium oxide is preferable.

The crystal form of the titanium oxide may be any of a rutile type, an anatase type, and a brookite type. The anatase type having a small specific gravity is preferable from the viewpoint of easily reducing the particle diameter of the white pigment, and the rutile type having a large refractive index in the visible light region is preferable from the viewpoint of further enhancing the concealing property of the image to be formed.

The content of the coloring agent is preferably 0.1% by mass to 10.0% by mass and more preferably 1.0% by mass to 5.0% by mass based on the total mass of the inkjet ink. When the coloring agent includes a white pigment, the content of the white pigment is preferably 3.0% by mass to 8.0% by mass.

### 1-3-2. Pigment-Dispersing Agent

The inkjet ink may contain a pigment-dispersing agent for dispersing a pigment.

Examples of the pigment-dispersing agent include hydroxyl group-containing carboxylic acid esters, salts of long-chain polyaminoamides and high-molecular-weight acid esters, salts of high-molecular-weight polycarboxylic acids, salts of long-chain polyaminoamides and polar acid esters, high-molecular-weight unsaturated acid esters, polymer copolymers, modified polyurethanes, modified polyacrylates, polyether ester-type anionic active agents, naphthalenesulfonic acid-formalin condensate salts, aromatic sulfonic acid-formalin condensate salts, polyoxyethylene alkyl phosphate esters, polyoxyethylene nonylphenyl ether, and stearylamine acetate. Examples of commercially available pigment-dispersing agents include the Ajisper series (manufactured by Ajinomoto Fine-Techno Co., Ltd.).

The content of the pigment-dispersing agent is preferably 10% by mass to 200% by mass, and more preferably 20% by mass to 100% by mass, based on the total mass of the pigment. When the content of the dispersant is 10% by mass or more based on the total mass of the pigment, the dispersion stability of the pigment is enhanced, and when the content of the dispersant is 200% by mass or less based on the total mass of the pigment, the ejectability of the ink from an inkjet head is readily stabilized.

### 1-3-3. Polymerization Initiator

The inkjet ink according to the present embodiment may contain an active ray polymerization initiator (hereinafter, simply referred to as “polymerization initiator”). The polymerization initiator may be any polymerization initiator that can initiate polymerization of the active ray polymerizable compound described above upon irradiation with active rays. For example, when the inkjet ink contains a radically polymerizable compound, the polymerization initiator can be a radical polymerization initiator. Furthermore, for example, when the inkjet ink contains a cationically polymerizable compound, the polymerization initiator can be a cationic polymerization initiator (photoacid generator). Note that no polymerization initiator is required when the inkjet ink can be sufficiently cured without a polymerization initiator, such as when the inkjet ink is cured by irradiation with electron beams.

Examples of the radical polymerization initiator include intramolecular bond cleavage type radical polymerization initiators and intramolecular hydrogen abstraction type radical polymerization initiators.

Examples of the intramolecular bond cleaving type radical polymerization initiators include the following:
acetophenone-based initiators including diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl-(2-hydroxy-2-propyl) ketone, 1-hydroxycyclohexyl-phenyl ketone, 2-methyl-2-morpholino (4-methylthiophenyl) propan-1-one, 2-benzyl-2-dimethylamino-1-(4-morpholinophenyl)-butanone and the like;
benzoins including benzoin, benzoin methyl ether, benzoin isopropyl ether, and the like;
acylphosphine oxide-based initiators including phenyl bis(2,4,6-trimethylbenzoyl) phosphine oxide (product name: Omnirad 819, manufactured by IGM Resins B.V.), and the like; and
benzyl and methylphenyl glyoxy esters and the like.

Examples of the intramolecular hydrogen abstraction type radical polymerization initiators include the following:
benzophenone-based initiators including benzophenone, methyl o-benzoylbenzoate, 4-phenylbenzophenone. 4,4′-dichlorobenzophenone, hydroxybenzophenone, 4-benzoyl-4′-methyl-diphenyl sulfide, acrylated benzophenone. 3,3′,4,4′-tetra (t-butylperoxycarbonyl)benzophenone, and 3,3-dimethyl-4-methoxybenzophenone, and the like;
thioxanthone-based initiators including 2-isopropylthioxanthone, 2,4-dimethylthioxanthone, 2,4-diethylthioxanthone, 2,4-dichlorothioxanthone, and the like;
aminobenzophenone-based initiators including Michler's ketone, 4,4′-diethylaminobenzophenone, and the like; and
10-butyl-2-chloroacridone, 2-ethylanthraquinone, 9-, 10-phenanthrenequinone, camphorquinone, and the like.

Examples of the cationic polymerization initiator include photoacid generators. Examples of the photoacid generators include the following:
B(C₆(F₅)₄⁻, PF₆⁻, AsF₆⁻, SbF₆⁻, CF₃SO₃⁻ salts of aromatic onium compounds including diazonium, ammonium, iodonium, sulfonium, and phosphonium;
sulfonated products generating sulfonic acid;
halide photogenerating hydrogen halides; and
iron-allene complexes.

The content of the polymerization initiator is not particularly limited as long as the content is within a range in which the inkjet ink is sufficiently cured by irradiation with active rays (for example, ultraviolet rays) and the coatability on the surface of the base material is not deteriorated. For example, the content of the polymerization initiator is preferably 0.1% by mass to 20% by mass, and more preferably 1% by mass to 10% by mass, based on the total mass of the inkjet ink.

### 1-3-4. Polymerization Inhibitor

In the present embodiment, the inkjet ink may contain a polymerization inhibitor.

Examples of the polymerization inhibitor include (alkyl) phenols, hydroquinones, catechols, resorcinols, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) anilineoxide, dibutylcresol, cyclohexanoneoximecresol, guaiacol, o-isopropylphenol, butyraldoxime, methylethylketoxime, cyclohexanoneoxime and the like.

The content of the polymerization inhibitor is not particularly limited, but is preferably 0.1% by mass to 10% by mass based on the total mass of the inkjet ink.

### 1-3-5. Surfactant

In the present embodiment, the inkjet ink may contain a surfactant for adjusting the surface tension.

Examples of the surfactant include the following:
anionic surfactants including dialkylsulfosuccinates, alkylnaphthalenesulfonates and fatty acid salts;
nonionic surfactants including polyoxyethylene alkyl ethers, polyoxyethylene alkyl allyl ethers, acetylenic glycols, and polyoxyethylene-polyoxypropylene block copolymers;
cationic surfactants including alkylamine salts and quaternary ammonium salts; and
silicone-based surfactants and fluorine-based surfactants.

Examples of commercially available silicone-based surfactants include KF-351A, KF-352A, KF-353, KF-354L, and KF-355A (all manufactured by Shin-Etsu Chemical Co., Ltd).

The content of the surfactant is not particularly limited, but is preferably 0.001% by mass to 10% by mass, more preferably 0.001% by mass to 1.0% by mass based on the total mass of the inkjet ink.

In the present embodiment, the inkjet ink may contain, in addition to the above-described components, a fixing resin, a viscosity modifier, a specific resistance modifier, a film forming agent, an ultraviolet absorber, an antioxidant, an anti-fading agent, an antifungal agent, a rust-preventive agent, and the like, as necessary.

### 1-4. Physical Properties of Inkjet Ink

The viscosity of the inkjet ink at 80° C. is preferably 3 mPa·s to 20 mPa·s, and more preferably 5 mPa·s to 15 mPa·s. Due to this, in the inkjet head, it is possible to increase the ejection properties when the inkjet ink is heated and ejected.

The viscosity can be measured by a rheometer. For example, the pre-coating agent is heated to 100° C. and the inkjet ink is cooled to 20° C. under conditions of a shearing rate of 11.7 (1/s) and a temperature lowering rate of 0.1° C./s while measuring the viscosity with a stress-control-type rheometer (manufactured by AntonPaar GmbH. Physica MCR301 (75 mm of cone plate diameter, cone angle of) 1.0°, to obtain a temperature change curve of viscosity. The viscosity can be determined by reading the viscosity at 80° C. from the obtained temperature change curve.

Furthermore, the viscosity of the inkjet ink at 35° C. is preferably 3 Pa·s or more, more preferably 10 Pa·s or more, and even more preferably 15 Pa·s or more. The upper limit of the viscosity is not particularly limited, but is, for example, 300 Pa·s. The viscosity can be determined by reading the viscosity at 35° C. from the temperature change curve described above.

### 1-5. Method for Preparing Inkjet Ink

The inkjet ink can be prepared by mixing the above-described wax, polymerizable compound, and optional other components under heating. At this time, the obtained mixed liquid is preferably filtered through a predetermined filter. Note that when an ink containing a pigment is prepared, it is preferable to prepare a pigment dispersion liquid containing the pigment and an active ray polymerizable compound and then mix the pigment dispersion liquid with other components. The pigment dispersion liquid may further contain a dispersant.

The pigment dispersion liquid can be prepared by dispersing a pigment in a polymerizable compound. The pigment may be dispersed using, for example, a ball mill, a sand mill, an attritor, a roll mill, an agitator, a Henschel mixer, a colloid mill, an ultrasonic homogenizer, a pearl mill, a wet jet mill, or a paint shaker. At this time, a dispersant may be added.

Note that in the case of using a plurality of polymerizable compounds, the polymerizable compounds may be mixed first to prepare a polymerizable composition, and then the polymerizable composition, the wax, and any other component may be mixed under heating.

### 2. Image Forming Method

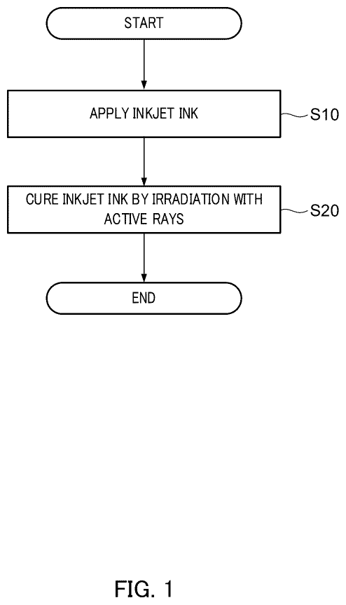

FIG. 1 is a flowchart illustrating an image forming method according to the present embodiment. The image forming method according to the exemplary embodiment includes a step (step S10) of discharging liquid droplets of the inkjet ink from an inkjet head and applying the liquid droplets to a surface of a base material and a step (step S20) of irradiating the applied liquid droplets of the inkjet ink with active rays and curing the liquid droplets.

### 2-1. Step of Applying Inkjet Ink to Base Material (Step S10)

In this step, the above-described inkjet ink is ejected from an inkjet head and applied to the surface of a base material (at a position corresponding to an image to be formed).

The method of ejecting the inkjet ink from the inkjet head may be either an on-demand method or a continuous method.

The on-demand type inkjet head may be any one of the following:
electro-mechanical conversion methods such as a single cavity type, a double cavity type, a bender type, a piston type, a share mode type, and a shared wall type; and
electrothermal conversion methods such as a thermal inkjet type and a bubble jet (“bubble jet” is a registered trademark of Canon Inc.) type.

Further, the inkjet head may be either a scan type or a line type inkjet head.

Since the droplets of the inkjet ink are discharged in a heated and solated state, the temperature of the inkjet ink at the time of filling the inkjet head is preferably set to the gelation temperature of the inkjet ink+10° C. or more and the gelation temperature+30° C. or less. When the temperature of the inkjet ink in the inkjet head is equal to or higher than the gelation temperature+10° C. a decrease in the ejectability due to gelation of the ink in the inkjet head or on the nozzle surface is less likely to occur. On the other hand, when the temperature of the ink in the inkjet head is the gelation temperature+30° C. or less, deterioration of the components due to a high temperature is less likely to occur. Note that the gelation temperature of the inkjet ink is measured by the following method. The inkjet ink is heated to 100° C. and the ink is cooled to 20° C. under conditions of a shearing rate of 11.7 (1/s) and a temperature lowering rate of 0.1° C./s while measuring the viscosity with Physica MCR301 (75 mm of cone plate diameters, cone angle of) 1.0° manufactured by AntonPaar GmbH. The gelation temperature is defined as a temperature at which the viscosity becomes 200 mPa·s in a temperature change curve of viscosity.

The method of heating the inkjet ink is not particularly limited. For example, at least any of an ink supply system such as an ink tank, a supply pipe, and a front chamber ink tank immediately before the head, piping with a filter, a piezoelectric head, and the like constituting a head carriage can be heated with a panel heater, a ribbon heater, heat-retaining water, and the like.

The ejected droplet amount of the inkjet ink is preferably 2 pL or more and 20 pL or less from the viewpoint of further increasing the recording speed and the image quality.

The base material is not particularly limited, and normal uncoated paper, coated paper and the like, as well as synthetic paper YUPO (“YUPO” is a registered trademark of Yupo Corporation), various plastics used for flexible packaging, and films thereof can be used. Examples of the various types of plastic films include a PP film, a PET film, an OPS film, an OPP film, an ONy film, a PVC film, a PE film, and a TAC film. Other plastics that can be used include polycarbonate, (meth)acrylic resin, ABS, polyacetal, PVA, and rubbers.

The base material temperature at the time the inkjet ink is deposited on the base material is preferably a temperature lower than the gelation temperature of the inkjet ink by 1° C. to 25° C. more preferably a temperature lower by 5° C. to 25° C. and even more preferably a temperature lower by 10° C. to 25° C. Setting the temperature of the base material within such a range facilitates achieving both the pinning property of the inkjet ink and the varnish suitability of an image obtained from the inkjet ink.

### 2-2. Step of Curing Inkjet Ink (Step S20)

In this step, the droplets of the inkjet ink applied to the base material in step S10 are irradiated with active rays to cure the droplets. Thus, an image formed of a cured film of the inkjet ink is formed.

The active rays can be selected from, for example, electron beams, ultraviolet rays, α rays, γ rays, and X-rays, and is preferably ultraviolet rays or electron beams. The ultraviolet rays are preferably light having peak wavelengths in a range of 360 nm or more and 410 nm or less. Furthermore, the ultraviolet rays are preferably emitted from an LED light source. An LED emits less radiant heat than a conventional light source (e.g., a metal halide lamp). Therefore, when an LED emits active rays, the ink is less likely to be melted, and gloss unevenness and the like are less likely to occur.

### 3. Step of Performing Varnish Processing on Image

In the step of performing varnish processing on the image layer, varnish processing is performed on the image formed by the image forming method for the purpose of aesthetic appearance and protection. In a case of an inkjet ink that does not require drying, varnish processing can be performed immediately after image formation.

Varnish processing is a technique of coating the image surface of a recorded product with varnish and is carried out for the purposes of imparting gloss to the image surface to impart a high-quality feel to the recorded product and improving the abrasion resistance and chemical resistance of the image surface.

As the varnish, commercially available products can be used, and examples thereof include PL-LV varnish for digital printing. KM-EP dedicated varnishes KM-2 and KM-3, UV roll coat varnishes RI-13, RI-13-K2, RI-16, RI-FX-3, RI-XG33, CX-1, CX-2, and CX-3, UV coat varnish AT-B, UV VECTA coat varnish PC-PC (manufactured by T&K TOKA Corporation), UV gloss varnish ULTRASHEEN UV-PC (manufactured by ACTEGA), UV matte varnish 3KW2, Soft Touch ULTRASHEEN UV-9021A (manufactured by KUSTOM & GROU), Plussize (registered trademark) OP-5267, OP-5275 (manufactured by Goo Chemical Co., Ltd), FD clear coat 5070E, C-YS (manufactured by Toyo Ink Co., Ltd.). Brightone (registered trademark), TUV (manufactured by Sakata Inks Co., Ltd), and XT3037 DC POD clear UV SP-001 to 003 (manufactured by DIC Corporation).

Above all, a varnish suitable for oil-based applications is preferable from the viewpoint of adhesiveness. Specific examples of varnishes suitable for oil-based applications include UV VECTA coat varnish 3KW2 PC-Varnish (manufactured by T&K TOKA Co., Ltd), Plussize (registered trademark) OP-5267 and OP-5275 (manufactured by Goo Chemical Co., Ltd), and FD Clear Coat C-YS (manufactured by Toyo Ink Co., Ltd).

The method of applying the varnish is not particularly limited, and may be an inkjet method or a method other than the inkjet method. Examples of methods other than the inkjet method include bar coating, spray coating, curtain coating, roll coating, screen printing, offset printing, gravure printing, methods using a plate such as a relief plate and an intaglio plate, and other methods not using a plate. Among these, screen printing, offset printing, gravure printing, or bar coating is preferable from the viewpoint of case of operation and uniform application properties.

From the viewpoint of further simplifying the apparatus configuration and reducing the cost of image formation, the method of applying varnish is particularly preferably an inkjet method.

In addition, in a case where the varnish is an active ray-curable varnish, after the varnish is applied onto the image layer, the varnish is irradiated with active rays to be cured. From the viewpoint of facilitating the setting of the apparatus and efficiently forming an image, the conditions for irradiating the varnish with active rays are preferably the same as the conditions for irradiating the inkjet ink with active rays.

In the varnish processing, a step of forming an image and a step of performing varnish processing on an image layer may be performed by different machines or may be performed at different places of the same machine. A step of conveying the base material on which the image layer is formed may be included between the step of forming the image layer and the step of performing the varnish processing on the image layer. The conveyance speed of the base material is preferably in a range of 30 to 120 m/min from the viewpoint of increasing the speed.

### 4. Image Forming Apparatus

An image forming apparatus 100 capable of carrying out the above-described image forming method will be described below.

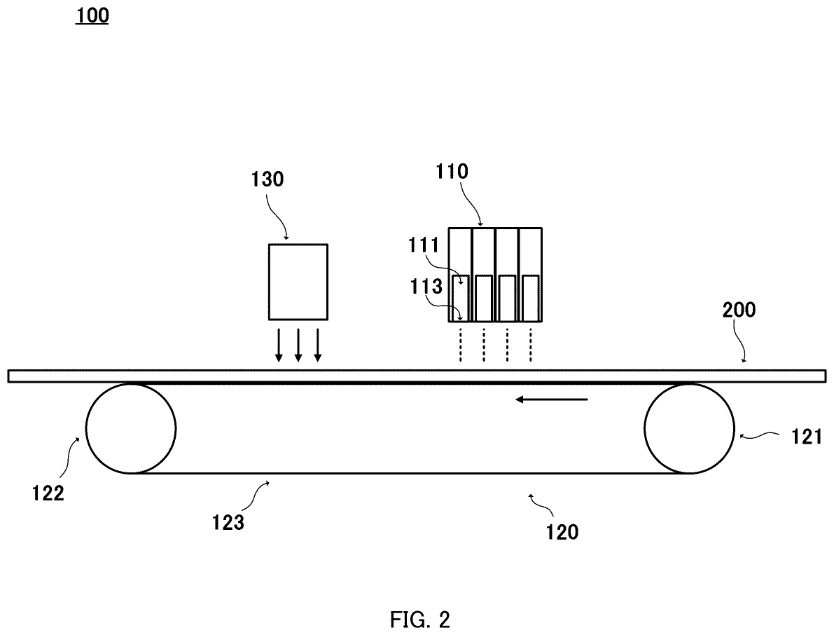

FIG. 2 is a schematic diagram illustrating a configuration of the image forming apparatus 100 according to the present embodiment. As illustrated in FIG. 2, the image forming apparatus 100 includes an inkjet head 110, a conveyance section 120, and an irradiation section 130. In FIG. 2, the arrow indicates the conveyance direction of the base material.

The inkjet head 110 includes a nozzle surface 113 provided with ejection ports of nozzles 111, on a surface facing the conveyance section 120 during formation of an image, and ejects inkjet ink onto the base material 200 conveyed by the conveyance section 120. From the viewpoint of enhancing the ejectability of the inkjet ink, the inkjet head 110 may include a temperature adjustment means for adjusting the temperature of the ink to adjust the ink to have a low viscosity. Examples of the temperature adjusting means include heating means using a panel heater, a ribbon heater, and heat-retaining water.

The inkjet head 110 may be a scan type inkjet head in which the width in the direction orthogonal to the conveyance direction of the base material is smaller than the base material 200, or may be a line type inkjet head in which the width in the direction orthogonal to the conveyance direction of the base material is larger than the base material 200.

The nozzle 111 includes an ejection port in the nozzle surface 113. The number of nozzles 111 may be equal to or greater than the number of inks used for image formation (for example, four).

The conveyance section 120 conveys the base material 200 so that the base material 200 facing the inkjet head 110 immediately below the inkjet head 110 moves in the vertical direction when an image is formed. For example, the conveyance section 120 includes a driving roller 121, a driven roller 122, and a conveyance belt 123.

The irradiation section 130 irradiates the upper surface of the conveyance section 120 with active rays. As a result, it is possible to cure the liquid droplets by irradiating the liquid droplets of the inkjet ink deposited on the transported base material 200 with active rays. The irradiation section 130 can be disposed immediately above the conveyance section 120 on the downstream side of the inkjet head 110.

The image forming apparatus 100 may include, in addition to the above-described configuration, an ink tank (not illustrated) for storing the inkjet ink before ejection and an ink channel (not illustrated) that allows the ink tank to communicate with the inkjet head 110 so that the inkjet ink can flow therethrough. The image forming apparatus 100 may also include a controller (not illustrated) that controls the operation of the inkjet heads 110, the conveyance section 120, and the irradiation section 130.

Further, the image forming apparatus 100 may include an intermediate transfer member and a transfer section (both not illustrated). At this time, the inkjet head 110 discharges the inkjet ink to the intermediate transfer body to deposit the inkjet ink on the surface of the intermediate transfer body, and forms an intermediate image formed by collecting liquid droplets of the inkjet ink on the surface of the intermediate transfer body. Thereafter, the transfer unit transfers the intermediate image from the surface of the intermediate transfer member to the surface of the base material. Next, the irradiation section 130 irradiates the intermediate image transferred onto the surface of the base material with active rays to cure the inkjet ink droplets.

### EXAMPLES

In the following, the present invention will be described with reference to an example. The scope of the present invention should not be construed as being limited to the examples.

### 1. Preparation/Synthesis of Materials

The materials used in the preparation of the inkjet inks are shown below.

### 1-1. Wax

Stearyl stearate (melting point: 50.0° C.)
Cetyl palmitate (melting point: 40.0° C.)
Behenyl behenate (melting point: 79.0° C.)
Stearone (melting point: 62.0° C.)
Behenyl stearate (melting point: 67.0° C.).
Pentaerythritol tetrastearate (melting point: 64.0° C.)

Note that the melting point of each wax was obtained using a differential scanning calorimeter “Diamond DSC” (manufactured by PerkinElmer. Inc). The melting point was measured under measurement conditions (heating and cooling conditions) including a first heating process of heating from room temperature (25° C.) to 110° C. at a temperature raising and lowering rate of 10° C./min and isothermally holding at 110° C. for 5 minutes, a cooling process of cooling from 110° C. to 0° C. at a cooling rate of 10° C./min and isothermally holding at 0° C. for 5 minutes, and a second heating process of heating from 0° C. to 110° C. at a temperature raising and lowering rate of 10° C./min, in this order. The measurement was performed by sealing 3.0 mg of the sample in an aluminum pan, and setting the pan in a sample holder of a differential scanning calorimeter “Diamond DSC”. An empty aluminum pan is used as a reference.

In the above measurement, the endothermic curve obtained in the first temperature increase process was analyzed, and the top temperature of the endothermic peak (half-value width of 15° C. or less) derived from the crystalline polyester resin was referred to as the melting point (Tm) of the wax.

### 1-2. Polymerizable Compound

3EO modified trimethylolpropane triacrylate
Tricyclodecane dimethanol dimethacrylate
1,10-Decanediol dimethacrylate
Tricyclodecane dimethanol diacrylate
Neopentyl glycol diacrylate
Lauryl acrylate

### 1-3. Other Components

### 1-3-1. Pigment Dispersion Liquid

Nine parts by mass of a pigment-dispersing agent (EFKA-7701, manufactured by BASF) and 71 parts by mass of tripropylene glycol diacrylate were placed in a stainless steel beaker, and the mixture was heated and stirred for 1 hour while being heated to 65° C. on a hot plate. Next, the mixture was cooled to room temperature, 20 parts by weight of Pigment Black 7 (#52, manufactured by Mitsubishi Chemical Corporation) was added into the stainless steel beaker after the stirring, then, the mixture was put into a glass bottle together with 200 g zirconia beads (a diameter of 0.3 mm, manufactured by NIKKATO CORPORATION) and the glass bottle was hermetically sealed. This pigment-containing liquid was subjected to dispersion treatment using a paint shaker, and then the zirconia beads were removed to obtain a pigment dispersion liquid. Note that the time of the dispersion treatment was 4 hours.

### 1-3-2. Polymerization Initiator

Polymerization initiator: Omnirad 819 (manufactured by IGM Resins B. V.)

### 1-3-3. Polymerization Inhibitor and Surfactant

Polymerization inhibitor: Irgasutab UV-10 (manufactured by BASF)
Surfactant: KF-352A (manufactured by Shin-Etsu Chemical Co., Ltd)

### 1-4. Preparation of Inkjet Ink

The wax, the polymerizable compound, the pigment dispersion liquid, the polymerization initiator, and other additives were placed in a stainless steel beaker to obtain the composition indicated in Tables 1 and 2, and the mixture was stirred at 105° C. for 45 minutes. Thereafter, the mixture was filtered through a Teflon (registered trademark) 3 μm membrane filter produced by ADVANTEC to obtain each of inkjet inks of Examples 1 to 10 and Comparative examples 1 to 4.

### 1-5. Calculation of HSP Distance

The HSP value (dispersion term (dD), polar term (dP), and hydrogen-bonding term (dH)) of each wax and each polymerizable compound was calculated using computer software. Hansen Solubility Parameters in Practice 5th Edition 5.0. 13 (HSPiP, manufactured by Tegara Corporation), by inputting the chemical structural formula into the software. In addition, in a case where a plurality of types of polymerizable compounds are included, a value obtained by adding values each obtained by multiplying the parameter (dD, dP, and dH) of each polymerizable compound by a molar ratio of the corresponding compound in the inkjet ink was set as the parameter (dD, dP, and dH) of the mixture of the polymerizable compounds.

Next, the HSP distance between the high-melting point wax or the low-melting point wax and the polymerizable compound (or a mixture of polymerizable compounds in a situation in which a plurality of polymerizable compounds are included) was calculated by the following equation. In the following equation, the dispersion term, the polar term, and the hydrogen bond term of one component of each wax and (a mixture of) the polymerizable compound are represented by dD, dP, and dH, respectively, and the dispersion term, the polar term, and the hydrogen bond term of the other component are represented by dD′, dP′, and dH′, respectively.

$$HSP distance = {( 4 \times {( dD - {dD}^{′} )}^{2} + {( dP - {dP}^{′} )}^{2} + {( dH - {dH}^{′} )}^{2} )}^{1 / 2}$$

The HSP distance between the high-melting point wax or the low-melting point wax and (the mixture of) the polymerizable compound in each of the inkjet inks is indicated in Table 1 and Table 2.

### 1-6. Gelation Temperature

Regarding the inkjet inks of Examples 1 to 10 and Comparative examples 1 to 4, each ink was heated to 100° C. and the viscosity was measured with a stress control type rheometer manufactured by Physica, and MCR301 (75 mm of cone plate diameters, cone angle of) 1.0°, manufactured by AntonPaar. The ink was cooled to 20° C. under the conditions of a shear rate of 11.7 (1/s) and a temperature lowering rate of 0.1° C./s to obtain a temperature change curve of viscosity. The gelation temperature was determined as a temperature at which the viscosity became 200 mPa·s in a temperature change curve of viscosity. The gelation temperature of each inkjet ink is described in Table 1 and Table 2.

### 2. Image Formation

A single-color image was formed with one of the inkjet inks of Examples 1 to 10 and Comparative examples 1 to 4 using a line-type inkjet recording apparatus. The temperature of the inkjet head of the inkjet recording apparatus was set to 80° C. A solid image of 5 cm×5 cm was printed on a base material (OK Top Coat+127g, manufactured by Oji Paper Co., Ltd). After the image was formed, the ink was cured by irradiating the image with ultraviolet rays with an LED lamp (395 nm, water-cooled LED, manufactured by Phoscon Technology, Inc.) disposed in a downstream portion of the recording apparatus. As the recording head for ejection, a piezo head was used. The ejection conditions were such that the amount of one droplet was 9.0 pl, and the droplet was ejected at a liquid flow rate of about 6 m/s and recorded at 1200 dpi×1200 dpi resolutions. The recording speed was set to 500 mm/s. The image formation was performed under an environment of 23° C. and 55% RH, and the temperature of the base material at the time the inkjet ink was deposited was adjusted to 40° C. The term dpi represents the number of dots per inch (2.54 cm).

### 3 Evaluation

### 3-1. Ejection Property

The ink was discharged by an inkjet recording apparatus, and the presence or absence of nozzle deficiency and discharge bending was visually observed, and each inkjet ink was evaluated according to the following criteria. Note that 2 or more was defined as a practically usable level.
4: No nozzle deficiency was observed
3: Nozzle deficiency was observed in 1 to 5 nozzles out of the total 1024 nozzles
2: Nozzle deficiency was observed in 6 to 9 nozzles out of the total 1024 nozzles
1: Nozzle deficiency was observed in 10 or more nozzles out of the total 1024 nozzles

### 3-2. Pinning Property

Dots were printed by the above-described image forming method using each of the inkjet inks of Examples 1 to 11 and Comparative examples 1 to 4. When the 400 dots thus formed were observed under an optical microscope, it was confirmed that the active ray polymerizable compound was seeping out from the periphery of the dots. Here, the longest length from the center of the dot to the outer periphery of the portion where the active ray polymerizable compound seeps was defined as the “outer diameter” of the dot, and the length from the center of the dot to the outer periphery of the dot body (the portion where the active ray polymerizable compound begins to seep) was defined as the “inside diameter” of the dot. Next, the percentage of the number of dots in which the difference between the outer diameter and the inside diameter was 10% or more of the inside diameter was determined, and the pinning property was evaluated according to the following evaluation criteria. Note that 2 or more was defined as a practically usable level.
4: The percentage of the number was 0) to 5%
3: The percentage of the number was 6 to 10%
2: The percentage of the number was 11 to 20%
1: The percentage of the number was 21% or more and it has been confirmed that adjacent liquid droplets have coalesced

### 3-3. Varnish Suitability

To the solid image obtained by the above image forming method, varnish DC POD Clear UV SP-001 (manufactured by DIC Corporation) was applied with a wire bar to a thickness of 10 μm. The obtained coating film was exposed and cured (power 120 W/cm, cold mirror condensing type, irradiation length 100 mm, conveyor line speed 15 m/min, maximum illumination 220 mW/cm², light amount 300 mJ/cm²) by a UV irradiator with a conveyor (manufactured by Iwasaki Electric Co., Ltd). The obtained solid image after varnish application was magnified 100 times, checked for cissing of the varnish, and evaluated according to the following criteria. Note that 2 or more was defined as a practically usable level.
4: No pinholes and no streaks are generated in the image
3: The area ratio of pinholes to the image is less than 1%
2: The area ratio of pinholes to the image is 1% or more and less than 10%
1: The area ratio of pinholes to the image is 10% or more

Tables 1 and 2 show the results of the evaluations.

TABLE 1

| Material type | Material name | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Wax | Stearyl stearate | 6.00 | 4.00 | 4.00 | 4.00 | 0.20 | | | | | 4.00 |
| | Cetyl palmitate | | | | | 4.00 | | | 3.00 | 4.00 | |
| | Behenyl behenate | 0.06 | 0.04 | 0.15 | | | 0.35 | 0.30 | 0.04 | | 0.04 |
| | Stearone | | | | 0.15 | | | | | | |
| | Behenyl stearate | | | | | | 5.00 | | | 0.15 | |
| | Pentaerythritol | | | | | | | 4.00 | | | |
| | tetrastearate | | | | | | | | | | |
| Polymerizable | 3EO modified | | | | 68.3 | 40.2 | 39.6 | 40.1 | | | |
| compound | trimethylolpropane | | | | | | | | | | |
| | triacrylate | | | | | | | | | | |
| | Tricyclodecane | | | | 12.1 | 40.2 | 39.6 | 40.1 | | | |
| | dimehanol | | | | | | | | | | |
| | dimethacrylate | | | | | | | | | | |
| | 1,10-Decanediol | | 24.4 | 24.3 | | | | | 24.9 | 24.3 | |
| | dimethacrylate | | | | | | | | | | |
| | Tricyclodecane | | 56.1 | 56.0 | | | | | 56.6 | 56.0 | |
| | dimethanol diacrylate | | | | | | | | | | |
| | Neopentyl glycol | 7.9 | | | | | | | | | 8.1 |
| | diacrylate | | | | | | | | | | |
| | Lauryl acrylate | 70.5 | | | | | | | | | 72.4 |
| Other | Pigment dispersion | 10.0 | 10.0 | 10.0 | 10.0 | 10.0 | 10.0 | 10.0 | 10.0 | 10.0 | 10.0 |
| components | liquid | | | | | | | | | | |
| | Polymerization initiator | 5.0 | 5.0 | 5.0 | 5.0 | 5.0 | 5.0 | 5.0 | 5.0 | 5.0 | 5.0 |
| | Polymerization inhibitor | 0.2 | 0.2 | 0.2 | 0.2 | 0.2 | 0.2 | 0.2 | 0.2 | 0.2 | 0.2 |
| | Surfactant | 0.3 | 0.3 | 0.3 | 0.3 | 0.3 | 0.3 | 0.3 | 0.3 | 0.3 | 0.3 |
| Total amount | | 100.0 | 100.0 | 100.0 | 100.0 | 100.0 | 100.0 | 100.0 | 100.0 | 100.0 | 100.0 |
| Wax | (Content mass of high- | 1.0% | 1.0% | 3.8% | 3.8% | 5.0% | 7.0% | 7.5% | 1.3% | 3.8% | 1.0% |
| | melting point wax)/ | | | | | | | | | | |
| | (content mass of low- | | | | | | | | | | |
| | melting point wax) [%] | | | | | | | | | | |
| | (Melting point of high- | 29° C. | 29° C. | 29° C. | 12° C. | 10° C. | 12° C. | 15° C. | 39° C. | 27° C. | 29° C. |
| | melting point wax)- | | | | | | | | | | |
| | (melting point of low- | | | | | | | | | | |
| | melting point wax) [° C.] | | | | | | | | | | |
| HSP distance | HSP distance between | 2.57 | 3.14 | 3.14 | 4.75 | 3.50 | 4.10 | 4.70 | 2.90 | 2.90 | 2.57 |
| | low-melting point wax | | | | | | | | | | |
| | and polymerizable | | | | | | | | | | |
| | compound [—] | | | | | | | | | | |
| | HSP distance between | 2.99 | 3.50 | 3.50 | 5.00 | 3.73 | 4.07 | 4.07 | 3.50 | 3.64 | 2.99 |
| | high-melting point wax | | | | | | | | | | |
| | and polymerizable | | | | | | | | | | |
| | compound [—] | | | | | | | | | | |
| liquid physical | Gelation temperature | 47° C. | 49° C. | 53° C. | 54° C. | 48° C. | 57° C. | 46° C. | 47° C. | 49° C. | 47° C. |
| properties | [° C.] | | | | | | | | | | |
| Temperature | [symbol] T (gelation | 7° C. | 9° C. | 13° C. | 14° C. | 8° C. | 17° C. | 6° C. | 7° C. | 9° C. | 7° C. |
| condition | temperature-base | | | | | | | | | | |
| | material temperature) | | | | | | | | | | |
| | [° C.] | | | | | | | | | | |
| Ink | Ejection property | 3 | 3 | 3 | 3 | 3 | 3 | 3 | 4 | 3 | 3 |
| performance | Pinning property | 3 | 3 | 4 | 4 | 4 | 4 | 4 | 3 | 4 | 3 |
| | Varnish suitability | 3 | 3 | 3 | 4 | 4 | 3 | 3 | 3 | 3 | 3 |

TABLE 2

| Material type | Material name | Comp. Ex. 1 | Comp. Ex. 2 | Comp. Ex. 3 | Comp. Ex. 4 |
|---|---|---|---|---|---|
| Wax | Stearyl stearate | 3.50 | 4.00 | 3.60 | |
| | Cetyl palmitate | | 0.20 | | 4.00 |
| | Behenyl behenate | 1.00 | | 0.60 | |
| | Stearone | | | | 0.70 |
| | Behenyl stearate | | | | |
| | Pentaerythritol tetrastearate | | | | |
| Polymerizable | 3EO modified | | | | |
| compound | trimethylolpropane triacrylate | | | | |
| | Tricyclodecane dimehanol | | | | |
| | dimethacrylate | | | | |
| | 1,10-Decanediol | 24.0 | 24.0 | | |
| | dimethacrylate | | | | |
| | Tricyclodecane dimethanol | 56.0 | 56.3 | | |
| | diacrylate | | | | |
| | Neopentyl glycol diacrylate | | | 80.28 | |
| | Lauryl acrylate | | | | 79.8 |
| Other | Pigment dispersion liquid | 10.0 | 10.0 | 10.0 | 10.0 |
| components | Polymerization initiator | 5.0 | 5.0 | 5.0 | 5.0 |
| | Polymerization inhibitor | 0.2 | 0.2 | 0.2 | 0.2 |
| | Surfactant | 0.3 | 0.3 | 0.3 | 0.3 |
| Total amount | | 100.0 | 100.0 | 100.0 | 100.0 |
| Wax | (Content mass of high- | 28.6% | 2000.0% | 16.7% | 17.5% |
| | melting point wax)/(content | | | | |
| | mass of low-melting point | | | | |
| | wax) [%] | | | | |
| | (Melting point of high- | 29° C. | 10° C. | 29° C. | 22° C. |
| | melting point wax) − (melting | | | | |
| | point of low-melting point | | | | |
| | wax) [° C.] | | | | |
| HSP distance | HSP distance between low- | 3.14 | 3.14 | 8.01 | 1.70 |
| | melting point wax and | | | | |
| | polymerizable compound [—] | | | | |
| | HSP distance between high- | 3.50 | 2.90 | 8.42 | 1.96 |
| | melting point wax and | | | | |
| | polymerizable compound [—] | | | | |
| Liquid | Gelation temperature [° C.] | 56° C. | 40° C. | 35° C. | Not observed |
| physical | | | | | |
| properties | | | | | |
| Temperature | Δ T (gelation temperature − | 16° C. | 0° C. | −5° C. | — |
| condition | base material temperature) | | | | |
| | [° C.] | | | | |
| Ink | Ejection property | 1 | 3 | 1 | 1 |
| performance | Pinning property | 3 | 1 | 1 | 1 |
| | Varnish suitability | 1 | 3 | 1 | 1 |

As shown in Tables 1 and 2, when the two or more types of waxes satisfied (Requirement 1) to (Requirement 3), both the pinning property of the inkjet ink and the varnish suitability of the formed image could be achieved.

### INDUSTRIAL APPLICABILITY

The inkjet ink according to the present invention can sufficiently enhance the pinning property of the inkjet ink and enhance the varnish suitability of the image to be formed. Therefore, the present invention is useful in the field of image formation.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet ink curable by irradiation with an active ray, the inkjet ink comprising two or more types of waxes and a polymerizable compound, wherein:
a sum of masses of the two or more types of waxes is 1.0% by mass to 10.0% by mass based on a total mass of the inkjet ink; and
when, of two types of waxes composed of a wax having a largest content by mass and a wax having a second largest content by mass among the two or more types of waxes, a wax whose melting point is higher is referred to as a high-melting point wax and a wax whose melting point is lower is referred to as a low-melting point wax,
the melting point of the high-melting point wax is higher than the melting point of the low-melting point wax by 5° C. or more, and
a content mass of the high-melting point wax is 1.0% by mass to 10.0% by mass with respect to a content mass of the low-melting point wax.

2. The inkjet ink according to claim 1, wherein
an HSP distance between the high-melting point wax and the polymerizable compound and an HSP distance between the low-melting point wax and the polymerizable compound are both within a range of 2.5 to 6.5.

3. The inkjet ink according to claim 2, wherein:
the melting point of the high-melting point wax is higher than the melting point of the low-melting point wax by 10° C. or more;
the content mass of the high-melting point wax is 2.0% by mass to 6.0% by mass with respect to the content mass of the low-melting point wax; and
the HSP distance between the high-melting point wax and the polymerizable compound and the HSP distance between the low-melting point wax and the polymerizable compound are 3.5 to 5.5.

4. An image forming method, comprising:
ejecting the inkjet ink according to claim 1 from an inkjet head to deposit the inkjet ink on a surface of a base material; and
irradiating the deposited inkjet ink with an active ray to cure the inkjet ink,
wherein
a temperature of the base material at a time the inkjet ink is deposited is set to a temperature lower than a gelation temperature of the inkjet ink by 5° C. to 25° C.
